(19) United States
(12) Patent Application Publication
(10) Pub. No.: US 2015/0346942 A1
(43) Pub. Date: Dec. 3, 2015

(54) Drag & Drop for Defining Hierarchy

(71) Applicant: Intergraph Corporation, Madison, AL (US)

(72) Inventor: Hadas Oren, Yuvalim (IL)

(21) Appl. No.: 14/728,272

(22) Filed: Jun. 2, 2015

Related U.S. Application Data
(60) Provisional application No. 62/006,495, filed on Jun. 2, 2014.

(51) Int. Cl. G06F 3/0486; G06F 17/30; G06F 3/0484

(52) U.S. Cl. CPC G06F 3/0486; G06F 3/04847; G06F 3/04842; G06F 17/30572

(57) ABSTRACT

An intuitive graphical interface on a computer allows a user to quickly and easily create and edit plant hierarchy templates, and/or plant hierarchies, without having to leave the graphical editing environment. Hierarchies may represent complex data structures, and the graphical interfaces allow editing and manipulation of their graphical forms while creating or maintaining such complex structures.

### RELATED APPLICATIONS

The present application claims priority from U.S. provisional application Ser. No. 62/006,495, titled “Drag & Drop for Defining Hierarchy,” filed Jun. 2, 2014, naming Hadas Oren as inventor. The foregoing application is hereby incorporated herein by reference in its entirety.

### TECHNICAL FIELD

The present invention relates to organizing data for construction projects, and more particularly to a database for storing data for construction projects.

### BACKGROUND ART

In the prior art, data for construction projects was stored in a database, and editing such databases was done using dialog boxes.

Prior art systems were cumbersome for the users who had to open dialog boxes when creating and managing hierarchies. Editing a hierarchy required users to delete sub-elements of the hierarchy and then re-build the hierarchy. In addition, users were not able to rearrange plant group type locations inside a hierarchy template

### SUMMARY OF THE EMBODIMENTS

A first embodiment includes a graphical user interface for allowing a template editor to create a hierarchy template on a host computer, for later user by a plant designer. The graphical user interface has several graphical components displayed on a host computer's display screen, including at least one hierarchy template creation icon configured to create, when activated by a template editor, an editable hierarchy tile; a plant-group-type menu displaying a plurality of distinct plant-group-type icons, each of the plant-group-type icons representing a sub-area (or building block) of a plant or site, which sub-area or building block may be described by design files stored in a database, and configured for graphical selection by the template editor; a graphical editing interface configured to allow the template editor to edit an editable hierarchy tile to create a new hierarchy template. In particular, the graphical editing interface allows the template editor to edit an editable hierarchy tile by: selecting, from the plant-group-type menu, a first plant-group-type icon; graphically placing (e.g., dragging and dropping) the first plant-group-type icon into the editable hierarchy template; selecting, from the plant-group-type menu, a second plant-group-type icon; graphically placing the second plant-group-type icon into the editable hierarchy template, such that the second plant-group-type icon is graphically subordinate to the first plant-group-type icon, and saving the new hierarchy template to a computer memory.

Various embodiments may have a variety of other features. For example, in some embodiments, the graphical editing interface is further configured to allow the template editor to select, from the plant-group-type menu, a third plant-group-type icon; and graphically place the third plant-group-type icon into the tree structure of the editable hierarchy template, such that the third plant-group-type icon is graphically subordinate to the second plant-group-type icon, and such that none of the first plant-group-type icon, the second plant-group-type icon, and the third plant-group-type icon have more than one immediately subordinate icon. Indeed, in some embodiments, the graphical editing interface is further configured to automatically rearrange the first plant-group-type icon and the second plant-group-type icon when the template editor drops the third plant-group-type icon into the template.

While in some embodiments a plant-group-type icon may be only a graphical representation of a plant-group-type, in other embodiments each plant-group-type icon is an object including structural metadata describing data storage qualities of data that can be coupled to, or stored in, a database and associated with the plant-group type icon. For example, in some embodiments the structural metadata describes the plant-group-type icon as allowing the storage of P&ID drawings in a database associated with the hierarchy.

Some embodiments also include hierarchy template menu configured to graphically display at least one or more hierarchy template creation icons to make them available to the template editor.

Generally, a hierarchy template icon maybe used by a plant designer to define a hierarchy template for use by engineers and architects in organizing and storing documents relating to the design and development of a plant. To that end, another embodiment includes a graphical user interface for allowing a plant designer to create a hierarchy from a hierarchy template in a computer environment. The graphical user interface includes a graphical template menu displaying at least one hierarchy template icon, each of the at least one hierarchy template icons having a template hierarchy having a plurality of plant-group-type icons at unique levels of subordination; a plant-group-type menu displaying a plurality of distinct plant-group-type icons, each of the plant-group-type icons configured for graphical selection by the plant designer, and a graphical editing interface configured to allow the plant designer to create a new hierarchy from a hierarchy template.

Generally, a graphical editing interface allows the plant designer to create a new hierarchy from a hierarchy template by selecting from the graphical template menu a hierarchy template icon; selecting from the plant-group-type menu a first plant-group-type icon, and graphically placing (e.g., dragging and dropping) the first plant-group-type icon into the template hierarchy; selecting from the plant-group-type menu, a second plant-group-type icon, and graphically placing the second plant-group-type icon into the hierarchy template, subordinate to the first plant-group-type icon; and selecting from the plant-group-type menu a plurality of other plant-group-type icons, and graphically placing the plurality of plant-group-type icons into the hierarchy template, wherein any icon may have one or more of the other plant-group-type icons as an immediate subordinate.

In some embodiments, the graphical editing interface is further configured to automatically rearrange plant group type icons upon the addition, by the plant designer, of an additional plant group type icon into the hierarchy.

In some embodiments, the graphical editing interface is further configured to allow the plant designer to couple, to a plant group type icon within the hierarchy, a database.

In some embodiments, the graphical editing interface is further configured to allow the plant designer to graphically move a plant group type icon from one location within a hierarchy to another location within the hierarchy, and/or to allow the plant designer to change the name of a plant group type icon, which plant group type icon is within a hierarchy.

Some embodiments include, in the graphical editing interface, a site menu with a plurality of icons representing a corresponding plurality of sites.

Other embodiments may be implemented on a non-transient computer readable medium having computer-executable code thereon, the computer-executable code configured to display on a display device a graphical template menu displaying at least one hierarchy template icon, each of the at least one hierarchy template icons having a template hierarchy having a plurality of plant-group-type icons at unique levels of subordination; a plant-group-type menu displaying a plurality of distinct plant-group-type icons, each of the plant-group-type icons configured for graphical selection by the plant designer; and a graphical editing interface configured to allow the plant designer to create a new hierarchy from a hierarchy template, by: selecting from the graphical template menu a hierarchy template icon; selecting from the plant-group-type menu a first plant-group-type icon, and graphically placing the first plant-group-type icon into the template hierarchy; selecting from the plant-group-type menu, a second plant-group-type icon, and graphically placing the second plant-group-type icon into the hierarchy template, subordinate to the first plant-group-type icon; selecting from the plant-group-type menu a plurality of other plant-group-type icons, and graphically placing the plurality of plant-group-type icons into the hierarchy template, wherein any icon may have one or more of the other plant-group-type icons as an immediate subordinate.

In some embodiments, the graphical editing interface is further configured to allow the plant designer to couple, to a plant group type icon within the hierarchy, a database.

In some embodiments, the graphical editing interface is further configured to allow the plant designer to graphically move (e.g., drag and drop) a plant group type icon from one location within a hierarchy to another location within the hierarchy.

In some embodiments, the graphical editing interface further includes a site menu with a plurality of icons representing a corresponding plurality of sites, each site having at least one database.

Alternately, or in addition, some embodiments include computer-executable code configured to display (on the display device) at least one hierarchy template creation icon configured to create, when activated by a template editor, an editable hierarchy tile; a plant-group-type menu displaying a plurality of distinct plant-group-type icons, each of the plant-group-type icons representing a sub-area (or building block) of a plant or site, which sub-area or building block may be described by design files stored in a database, and configured for graphical selection by the template editor; the graphical editing interface further configured to allow the template editor to edit an editable hierarchy tile to create a new hierarchy template. For example, the graphical editing interface allows the template editor to edit an editable hierarchy tile to create a new hierarchy template by: selecting, from the plant-group-type menu, a first plant-group-type icon; graphically placing the first plant-group-type icon into the editable hierarchy template; selecting, from the plant-group-type menu, a second plant-group-type icon; graphically placing the second plant-group-type icon into the editable hierarchy template, such that the second plant-group-type icon is graphically subordinate to the first plant-group-type icon, and saving the new hierarchy template to a computer memory.

In some embodiments, the computer-executable code provides a graphical editing interface configured to allow the template editor to select, from the plant-group-type menu, a third plant-group-type icon; graphically place the third plant-group-type icon into the editable hierarchy template, such that the third plant-group-type icon is graphically subordinate to the second plant-group-type icon, and such that none of the first plant-group-type icon, the second plant-group-type icon, and the third plant-group-type icon have more than one immediately subordinate icon.

In some embodiments, the computer-executable code provides the graphical editing interface is further configured to automatically rearrange the first plant-group-type icon and the second plant-group-type icon when the template editor drops the third plant-group-type icon into the template.

In some embodiments, the computer-executable code provides each of the plant-group-type icons as an object including structural metadata describing data storage qualities of data that can be coupled to, or stored in, the database represented by the plant-group-type icon.

### BRIEF DESCRIPTION OF THE DRAWINGS

The foregoing features of embodiments will be more readily understood by reference to the following detailed description, with reference to the accompanying drawings, in which:

FIG. 1 schematically illustrates prior art data structures for recording plant hierarchies;

FIG. 2 schematically illustrates a computer system;

FIGS. 3A-3C schematically illustrate prior art user interfaces for creating and modifying plant hierarchies;

FIGS. 4A-4C schematically illustrate screenshots of an embodiment of a graphical system for creating and editing sites;

FIG. 5 schematically illustrates a portion of a hierarchy interconnected with a database;

FIG. 6A schematically illustrates a hierarchy template, and FIG. 6B schematically illustrates a hierarchy made using the template of FIG. 6A;

FIG. 6C schematically illustrates a hierarchy template, and FIG. 6D schematically illustrates a hierarchy made using the template of FIG. 6C.

### DETAILED DESCRIPTION OF SPECIFIC EMBODIMENTS

Embodiments provide an intuitive interface that allows a user to quickly and easily create and edit plant hierarchies, without having to leave the graphical editing environment.

Plant hierarchies are created beginning with hierarchy templates. Some embodiments allow a plant designer to use a pre-existing template to create a plant hierarchy through a plant design graphical user interface. Other embodiments allow a site or plant administrator (e.g., a hierarchy designer) to create a new hierarchy template through a hierarchy-template graphical user interface, which template can later be used by a plant designer to create a plant hierarchy. Although there are similarities the graphical user interface for creating a new plant hierarchy and the graphical user interface for creating a new hierarchy template, the two technologies differ in significant ways.

For example, some embodiments allow a hierarchy template designer to view hierarchies in a divided panel, and to create, edit and delete hierarchies while all the items appear on same screen. A Plant Group Type drag & drop option allows users to drag a Plant Group Type icon from a list view into a hierarchy template tile tree view, change its location within the hierarchy tree, or even delete it when possible, without opening even a single dialog box.

Other embodiments allow a plant designer to view hierarchy templates in a divided panel, and to select a pre-existing hierarchy template for use in designing a new hierarchy. After selecting a pre-existing hierarchy template, the plant designer can select any number of Plant Group Type icons and arrange them in a hierarchical structure within a graphical hierarchy based on the selected hierarchy template.

Some embodiments allow a single user to create a new hierarchy template while acting as a hierarchy template designer, and then use the newly-created hierarchy template to create a new hierarchy while acting as a plant designer.

Definitions. As used in this description and the accompanying claims, the following terms shall have the meanings indicated, unless the context otherwise requires:

A “plant” is a group of facilities and equipment that performs one or more functions within a given geographical area. One company can have several plants located at different geographical locations. A “plant” is not a biological organism. Examples of plants include, but are not limited to, power generation facilities; pharmaceutical production facilities; manufacturing facilities; offshore oil rigs, and even ships.

A “site” is a group of plants. A site can contain more than one plant.

A “hierarchy” is an organizational structure of data describing a plant. A plant may contain one or more hierarchies.

A “plant group type” (or “PGT”) is a building block of a plant, such as “Plant,” “Area,” and “Unit.” Plant group types are used to create plant breakdown structure. In a hierarchy template, a PGT may be represented by a graphical icon.

A “hierarchy template” is a template to create a plant structure, for example in a tree outline format, and defines the available plant group items for a certain level of the tree. A hierarchy template includes at least three items of plant group type. In some embodiments, except for the first (or superior) plant group type within a hierarchy, each item of plant group type is immediately and exclusively subordinate to another item of plant group type, so that no two items of plant group type are immediately subordinate to the same item of plant group type.

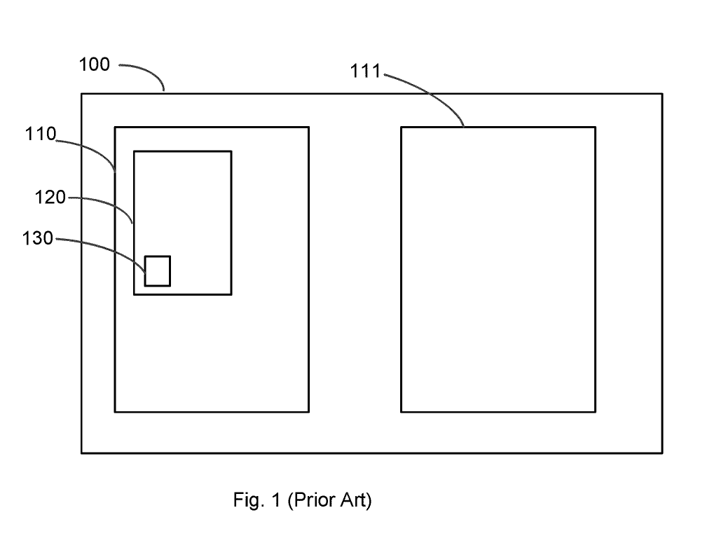

FIG. 1 schematically illustrates a graphical expression of a site 100, which is a database configured to store two hierarchies, or hierarchy templates, 110 and 111. Hierarchy template 110 is described in detail, and is generally representative of hierarchy template 111 and other hierarchies.

Site 100 is a collection of data, and may even be a database. For example, hierarchy template 110 includes an item 120 of plant group type. Item 120 is thus subordinate to hierarchy template 110. Item 120, in turn, includes a subordinate item 130 of plant group type.

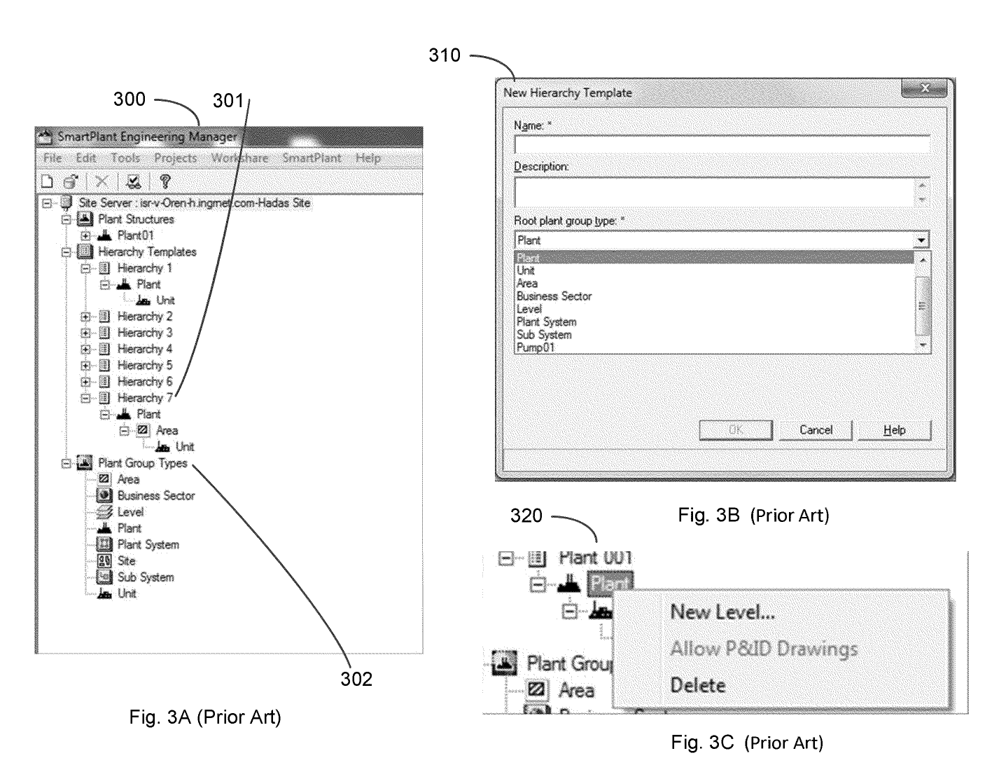

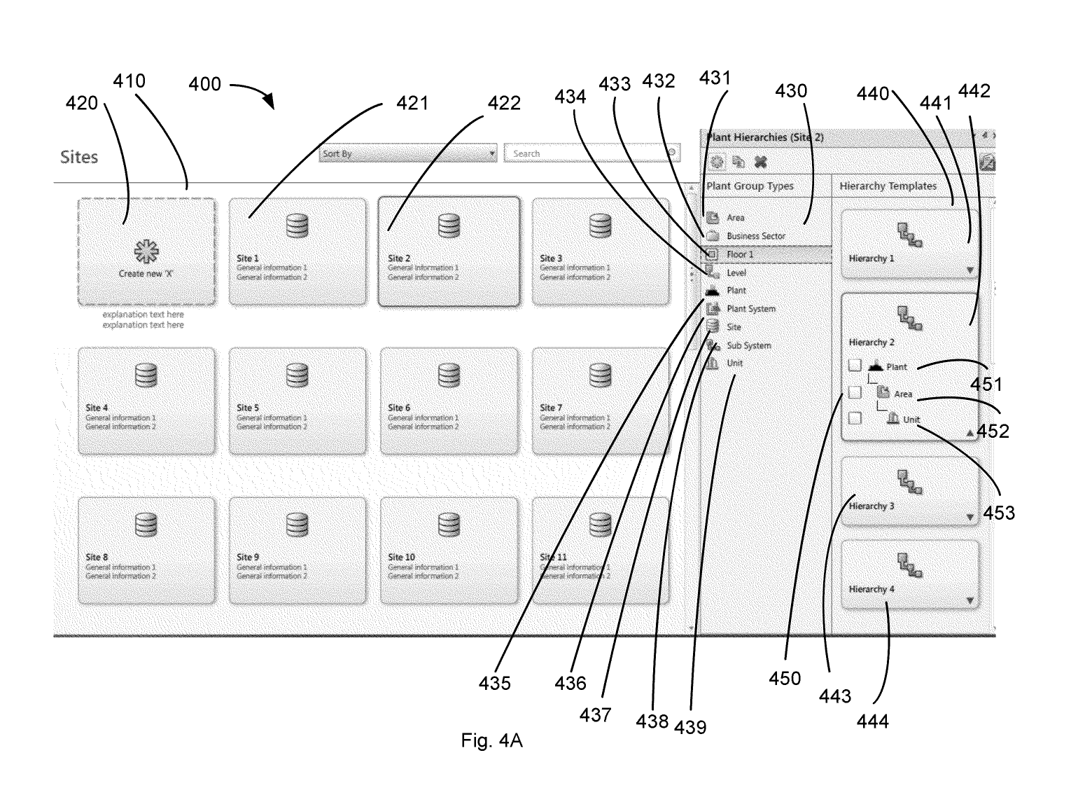

Prior art systems enabled the creation and editing of sites and hierarchies though pop-up windows. An example of a prior art user interface 300 showing a hierarchy 301 is schematically illustrated in FIG. 3A. The hierarchy 301 is shown in a tree view. In interface 300, a site includes seven hierarchy template (“Hierarchy 1” . . . “Hierarchy 7”), and two plant group types (“Plant” and “Unit”) as shown as subordinate to “Hierarchy 1.” Similarly, three plant group types (“Plant,” “Area,” and “Unit”) as shown as subordinate to “Hierarchy 7.” A list 302 of plant group types compatible with this site and its hierarchies is shown near the bottom of interface 300.

Creating and editing a site required, in the prior art, the use of pop-up windows, such as template 310 schematically illustrated in FIG. 3B, and pop-up menu 320 schematically illustrated in FIG. 3C.

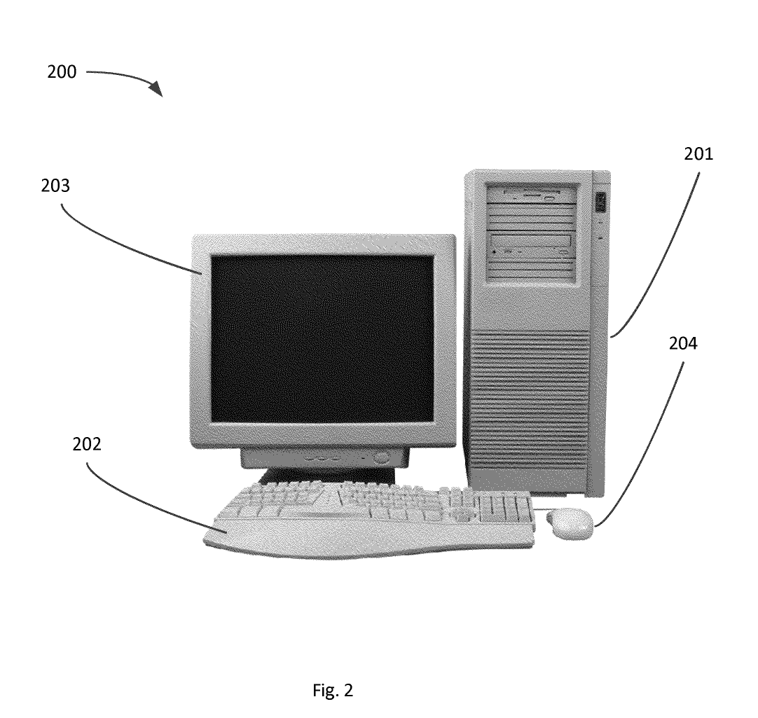

Illustrative embodiments may be implemented on a computer, such as computer 200 in FIG. 2. The computer 200 includes a CPU 201, a keyboard 202, and a monitor or image display device 203. The CPU 201 may include both dynamic memory and static memory, such as a hard disk drive, for example. The CPU also includes a microprocessor in communication with the memory and/or disk drive, and is configured to execute instructions stored in the memory and/or disk drive. To that end, the memory, the disk drive, or both, may be configured to be non-transient and to store executable computer instructions indefinitely. The instructions, when executed by the microprocessor, may implement some or all of the operations and actions described herein. The CPU may also include a communications interface configured to communicate with other systems to execute the operations and actions described herein. The computer 200 also includes a mouse 204, as commonly known.

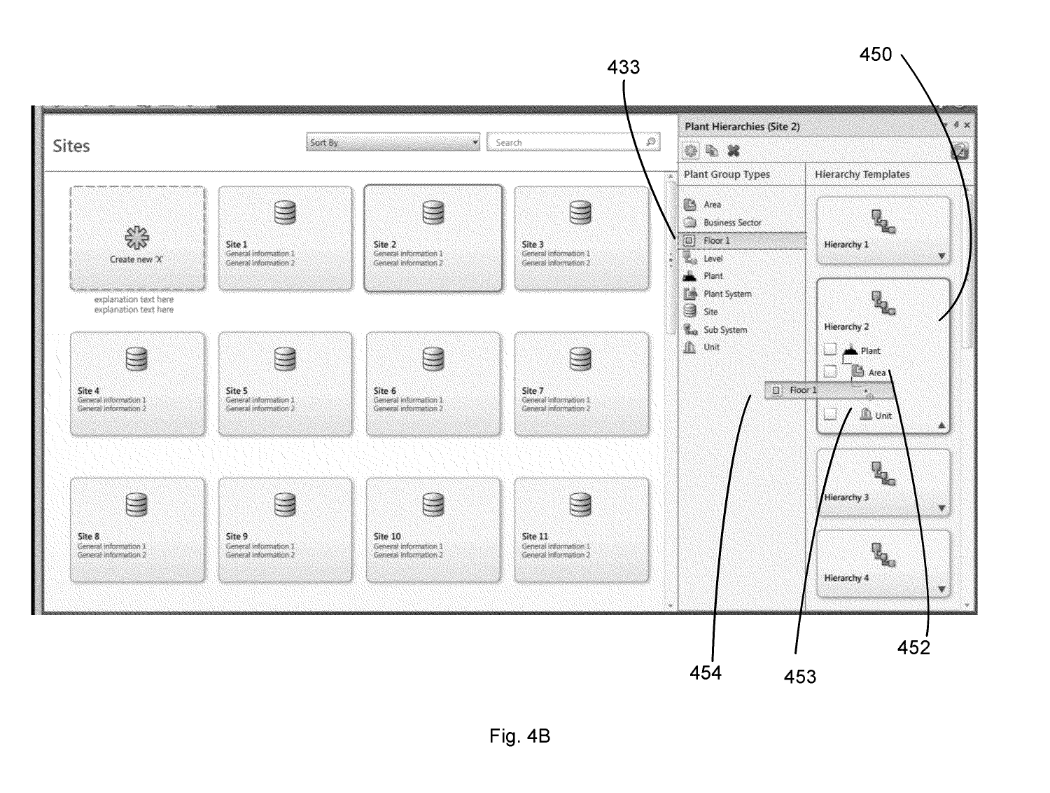

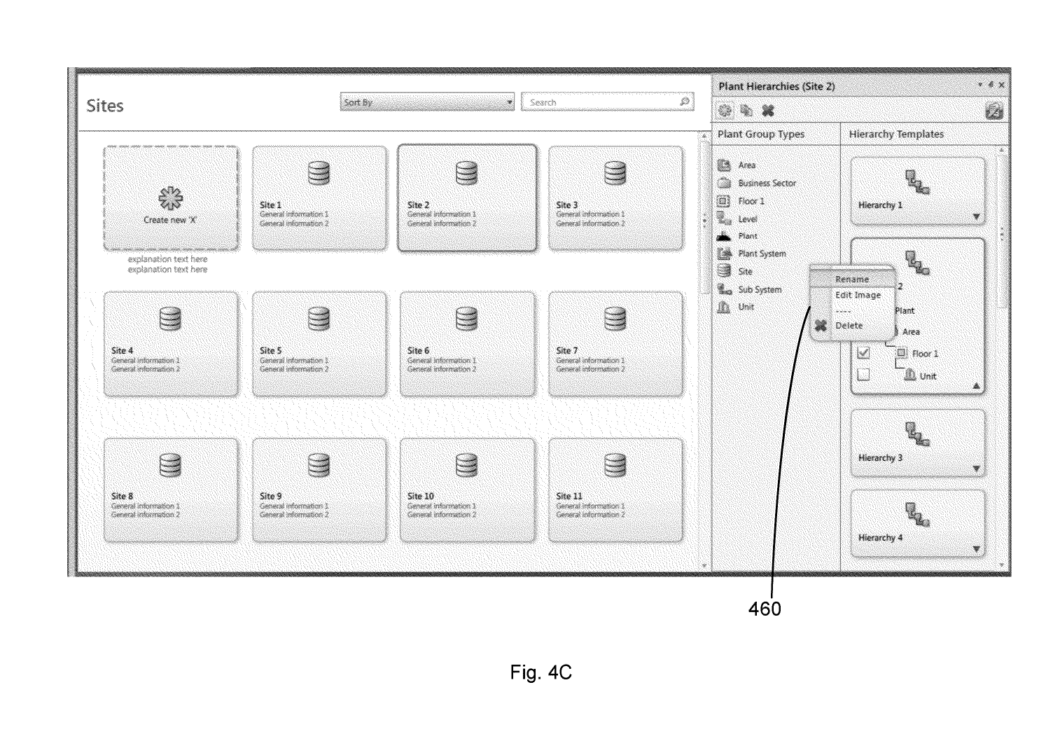

An embodiment of a graphical interface 400 is schematically illustrated in FIGS. 4A-4C. As shown, a user interface screen on an image display device includes a site menu 410 with icons representing several sites (e.g., 421, 422). Also shown is a “Create New” icon 420. Activating (e.g., using a mouse to click-on) the “Create New” icon 420 causes the system to create a new site database, which a user may then populate with one or more hierarchy templates.

In FIG. 4A, the user has selected site 422 (named “Site 2” in FIG. 4A).

The graphical interface 400 includes two menus to assist a user in creating and editing a site: a menu of “Plant Group Types” 430 and a menu of “Hierarchy Templates” 440.

The Plant Group Types menu 430 includes several pre-defined Plant Group Types icons 431-439 in a list view, including for example Area 431, Business Sector 432, Floor 433 and Level 434. A user may add any of the Plant Group Types represented by these icons 431-439 to a plant hierarchy by selecting an icon and graphically adding it to a hierarchy by using a drag and drop operation.

A plant group type icon (or “PGT icon”), such as “Floor 1” icon 433 for example, has a graphical form, and is not merely a text item (as found in prior art drop-down lists). In some embodiments, a PGT icon may have data content in addition to its graphical form. For example, such a PGT icon may include, and carry with it as it is placed into a hierarchy, structural metadata describing data storage qualities of data that can be coupled to, or stored in, the database associated with the plant group item. As just one example, some PGT icons are associated with (and graphically represent) a database for storing documents related to a part of a plant represented by the PGT icon, and therefore include structural metadata describing documents they may be stored in, or via, such plant group types (e.g., blueprints, schematic diagrams, etc.).

To take a factory as an illustrative plant to be designed, a production floor (e.g., which may be represented by the “Floor 1” icon 433) may include piping and instrumentation, electrical wiring; computer cabling, etc. Therefore, a template designer would know that architects and engineers would need one or more databases in which to store design documents describing the floor and its features. Consequently, the template designer would know that a template for use by the plant designer would benefit from inclusion of plant group items that represent the types of files that can be stored in such a database.

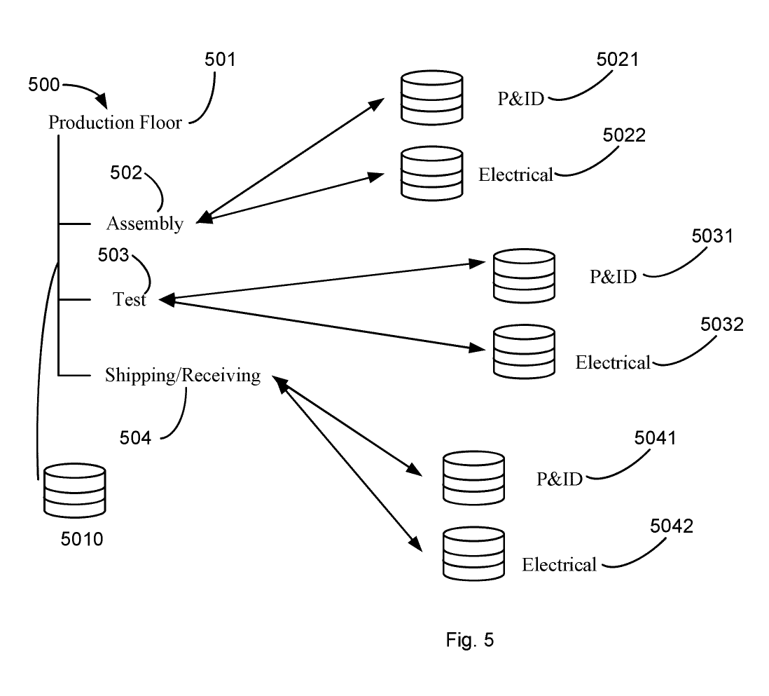

FIG. 5 schematically illustrates a hierarchy 500 for a production floor, in which the top plant group type 501 is “Production Floor.” In this example, the top plant group type 501 has several subordinate plant group types—“Assembly” 502, which represents an area in the factory where products are assembled, “Test” 503 which represents an area in the factory where products are tested, and “shipping/receiving” 504, which represents an area in the factory from products are shipped. To a plant designer, each of these areas would require documentation and a place to store the documentation. As such, each of the plant group type icon represents a type of data that may be stored in a database 5010 associated with the plant that includes the production floor. In FIG. 5, for example, plant group type 502 (Assembly) may represent that the database 5010 can store blueprints and other design documents associate with assembly area. Further, as indicated by double-headed arrows in FIG. 5, engineers and architects may locate, access (i.e., read from) and write (i.e., save to) documents in the database 5010 by use of the hierarchy 500, such as documents 5021 for storing piping and instrumentation diagrams (“P&ID”) and a documents 5022 for storing electrical schematic diagrams. The other plant group type icons (Test 503 and shipping/receiving 504) represent similar documents (5031 and 5032, and 5041 and 5042, respectively) associated with those areas. As described below, users of the database 5010 may have limited access to the content of the database 5010, so a given user may only have rights to access documents associated with a given plant-group-type, and may not have rights to access other documents in the database 5010 that are not associated with that plant-group-type. Therefore, the plant-group-type icons in a hierarchy present a convenient way for users to store and access documents, and for system administrators to control access to the content of the database 5010.

Hierarchy Templates

Referring to FIG. 4A, the Hierarchy Templates menu 440 includes several pre-defined hierarchy template icons, 441, 442, 443 and 444. Some or all of the hierarchies represented by the icons 441-444 may be pre-defined by the proprietor of the graphical interface 400, but some or all may also be custom designed by the user. Indeed the user may edit and save hierarchy templates and select them from the menu 440. Such a user may be referred to as a “template editor.”

In FIG. 4A, the user has selected hierarchy template 442 (named “Hierarchy 2”), which already includes a hierarchy 450 in a tree view, having Plant Group Types “Plant,” 451 “Area” 452 and “Unit” 453. The hierarchy template 442 is displayed in FIG. 4A as a tile, showing not just the template name, but also graphically showing the hierarchy tree 450 itself. Plant Group Type icon 451 is at the top of the hierarchy template 450, and PGT icon 452 is displayed below and horizontally offset from icon 451. Icon 452 is coupled to icon 451 by a line. This graphical arrangement in which icon 452 is below and horizontally offset from icon 451, and connected to icon 451 by a line, indicates to a viewer that that icon 452 is immediately subordinate, in the hierarchy structure 450, because icons 451 and 452 are linked to one another and no icon is between them in the hierarchy template 450. In some embodiments, an icon can have only one other icon that is immediately subordinate, in that no two icons can be simultaneously immediately subordinate to the same icon.

After selecting the Hierarchy Template 450, the user may edit the Hierarchy Template 450 and save the edited template, either to replace the pre-existing template 450 with the revised template, or to save it as a new template (e.g., in this example, the new template would be “Hierarchy 5”).

For example, in FIG. 4B, the user has selected PGT icon 433 (“Floor 1”), and dragged it into hierarchy template 450. The user has graphically placed the selected PGT icon 433 into the hierarchy template 450 so that it is graphically between icon 452 and icon 453. When the user “drops” the icon 432 into the hierarchy template 450, the system will add the icon 431 to the hierarchy template 450 as icon 454. Icon 454, and the PGT it represents, displaces icon 453 so that icon 453 is no longer immediately subordinate to icon 452. Rather, icon 454 is now immediately subordinate to icon 452, and icon 453 is immediately subordinate to icon 454. After placing a PGT icon in the hierarchy template 450, the user may move the icon to a different location in the hierarchy merely by dragging and dropping the icon with a mouse. The system will automatically adjust the graphical representation of the hierarchy to show the moved icon and its relationship to other icons (i.e., superior; subordinate, etc.).

Having edited the hierarchy template 450 to add new icon 454, the user may also modify the added icon 454, or may further edit the hierarchy, for example by right-clicking on the icon 454 to bring up an context menu 460 as schematically illustrated in FIG. 4C. For example, the user may rename the hierarchy template 450 from “Hierarchy 2” to any other name the user desires. However, renaming the hierarchy template 450 does not change any properties of the hierarchy template 450, so that the data-storage characteristics of the hierarchy template 450 do not change. Changing the name and/or graphical appearance of an icon or hierarchy template may make it easier for a user to recall details of the plant. For example, changing the name “Floor 1” for icon 454 to something descriptive of the purpose of the PGT (e.g., “Final Test Floor;” “Shipping;” “Wiring;” etc.) may make the hierarchy template more user friendly.

In addition, the user may delete a PGT icon from a hierarchy template, also using editing window 460, simply by clicking on the “Delete” option, or by dragging and dropping the PGT icon outside of the “Hierarchy 2” area. The system will remove the icon and re-draw the hierarchy template 450. An icon that was immediately subordinate to the deleted icon will be displayed as immediately subordinate to the superior icon from which the deleted icon was previously immediately subordinate.

Creating a Hierarchy Using a Hierarchy Template

A user may use the graphical interface 400 to develop a hierarchy using a template from the template menu 440. Such a user may be referred to as a “plant designer.”

If the plant designer does not find a satisfactory template in the template menu 440, the plant designer may assume the role of template editor and create a new hierarchy template, as described above.

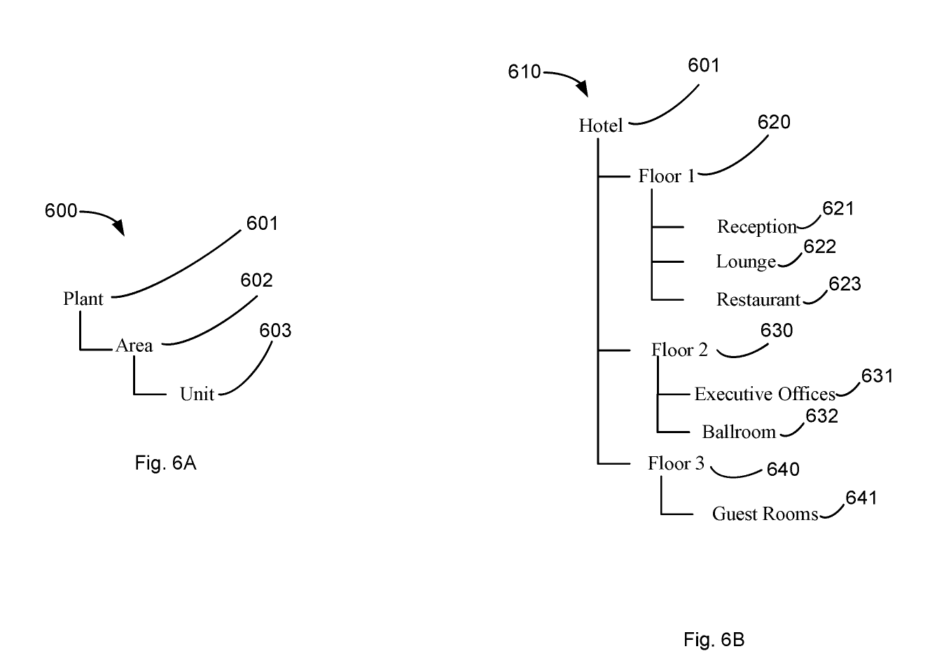

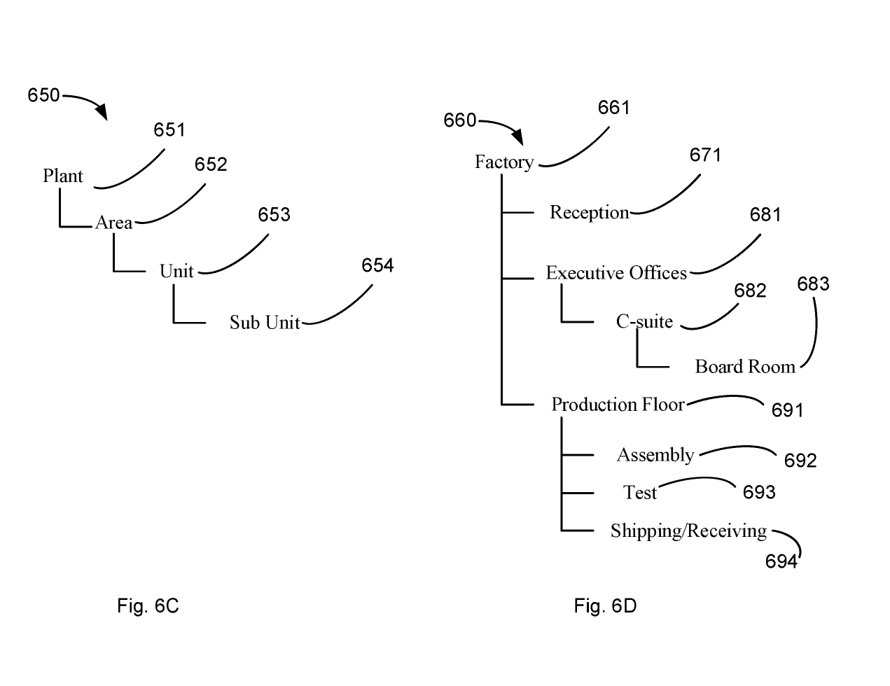

Once the plant designer identifies a suitable hierarchy template, the plant designer creates a new hierarchy by selecting that template, and editing its included hierarchy. For example, FIG. 6A schematically illustrates a hierarchy 600 having three plant group types. Plant group type 601 is the superior plant group type icon, in that all other plant group type icons in the hierarchy 600 are subordinate to plant group type icon 601. In this example, plant group type icon 601 is labeled “Plant.” Plant group type icon 602 (“Area”) is immediately subordinate to plant group type icon 601 in that no other plant group type icons intervene between plant group type icon 601 and plant group type icon 602. Similarly, plant group type icon 603 (“Unit”) is immediately subordinate to plant group type icon 602 in that no other plant group type icons intervene between plant group type icon 602 and plant group type icon 603.

The plant designer does not edit the hierarchy template 600, which is fixed (un-editable). Rather, the plant designer uses the hierarchy 600 as a new hierarchy (not a template), and edits the new hierarchy using the graphical user interface 400. For example, when a plant administrator creates a new plant, he selects an available hierarchy template, names the new plant, selects a database connection and defines paths for backup and plant structure. In some embodiments, saving a hierarchy causes the computer to create and save in the computer's memory a text file having certain data about the hierarchy, and/or a database (e.g., database 5010) for storing design documents describing the plant or site. For example, such a text file (or “ini” file) may contain the database type, connection alias, data dictionary, and schema information for the site

As an example, a plant designer may use template hierarchy 600 to create a new hierarchy 610 for a hotel, as schematically illustrated in FIG. 6B. In hierarchy 610, the plant designer has changed the name of plant group type icon 601 from “Plant” to “Hotel.”

Using plant group types 602 and 603 from template hierarchy 600, the plant designer has also added three plant group types that are immediately subordinate to plant group type 611. Note that, unlike some embodiments of hierarchy templates described above, a plant group type in a hierarchy can have more than one immediately subordinate plant group type.

Plant group type 620 (corresponding to plant group type 602 in the template 600) represents the first floor of the hotel, and includes three immediately subordinate plant group types (each corresponding to plant group type 603 in the template 600)—a reception area 621, a lounge 622, and a restaurant 623.

Similarly, plant group type 630 represents the second floor of the hotel, and includes two immediately subordinate plant group types—executive offices 631, and a ballroom 632.

In each case, starting with the hierarchy template 600, the plant designer selects the plant group type icons from the plant group type menu 430 and drags and drops each selected plant group type icon into the template to produce the hierarchy 610.

The third floor of the hotel is represented by plant group type 640, which has only a single subordinate plant group type for guest rooms 641.

As describe above, the plant group type icons included in the hierarchy 610 represent and associated database for storing plant design documents.

Typically, the plant designer does not populate the database with design documents, since that may be done by, e.g., engineers and architects developing the details of the plant design. To that end, the hierarchy 610 may be made available to such engineers and architects. However, access to various database may not be unlimited to such engineers and architects, in that each plant group type icon within the hierarchy may optionally include descriptive metadata (in this example, access authorization metadata) that includes access credentials or criteria that must be satisfied before a given user (e.g., engineer or architect) may write to, read or copy from, a given database. In this way, the access credentials or criteria serve, in part, to associate a plant group type icon with a database, and a subset of the content of that database maybe associated with the plant group type icon. Such descriptive metadata may supplied by the plant designer as part of defining the hierarchy 610. Note that plant group type icons (e.g., 601-603) within a template (e.g., 600) do not include such access authorization metadata, since they are generic prior to being cast into a specific hierarchy.

Neither hierarchy templates nor hierarchies are limited to three subordination levels as described above, or to any fixed number of levels. However, in some embodiments the number of subordination levels in a hierarchy is limited to the number of subordination levels in the hierarchy template from which the hierarchy is created. For example, if a hierarchy template has a hierarchy with three subordination levels (e.g., template hierarchy 600 in FIG. 6A), then a hierarchy created from that template will be limited to three subordination levels (e.g., hierarchy 610 in FIG. 6B).

Various embodiments are flexible enough to accommodate any size plant design to include any number of subordination levels and plant group types. For example, FIG. 6C schematically illustrated a hierarchy template 650 with three plant group types: superior plant group type 651, and successively subordinate plant group types 653-654. The hierarchy template 650 may be graphically edited in ways described above to produce a hierarchy 660, for example, in which plant group type 661 (“Factory”) corresponds to template plant group type 651 (“Plant”), plant group types 671, 681 and 691 correspond to template plant group type 652 (“Area”); plant group types 682, 692, 693 and 694 correspond to template plant group type 653 (“Unit”), and plant group type 683 corresponds to template plant group type 654 (“Sub Unit”).

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transient computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A graphical user interface for allowing a template editor to create a hierarchy template on a computer, for later user by a plant designer, the graphical user interface comprising:
at least one hierarchy template creation icon configured to create, when activated by a template editor, an editable hierarchy tile;
a plant-group-type menu displaying a plurality of distinct plant-group-type icons, each of the plant-group-type icons representing a sub-area of a plant to be described by design files stored in a database, and configured for graphical selection by the template editor;
a graphical editing interface configured to allow the template editor to edit an editable hierarchy tile to create a new hierarchy template, by:
selecting, from the plant-group-type menu, a first plant-group-type icon;
graphically placing the first plant-group-type icon into the editable hierarchy template;
selecting, from the plant-group-type menu, a second plant-group-type icon;
graphically placing the second plant-group-type icon into the editable hierarchy template, such that the second plant-group-type icon is graphically subordinate to the first plant-group-type icon in a tree structure, and
saving the new hierarchy template to a computer memory.

2. The graphical user interface of claim 1, where the graphical editing interface is further configured to allow the template editor to:
select, from the plant-group-type menu, a third plant-group-type icon;
graphically place the third plant-group-type icon into the editable hierarchy template, such that the third plant-group-type icon is graphically subordinate to the second plant-group-type icon in the tree structure, and such that none of the first plant-group-type icon, the second plant-group-type icon, and the third plant-group-type icon have more than one immediately subordinate icon.

3. The graphical user interface of claim 2, where the graphical editing interface is further configured to automatically rearrange the first plant-group-type icon and the second plant-group-type icon when the template editor drops the third plant-group-type icon into the template.

4. The graphical user interface of claim 1, where each of the plurality plant-group-type icons is an object including structural metadata describing data storage qualities of data that can be stored in a database associated with the plant-group-type icon.

5. The graphical user interface of claim 4, wherein the structural metadata describes the plant-group-type icon as allowing the storage of P&ID drawings.

6. The graphical user interface of claim 1, further comprising a hierarchy template menu configured to graphically display the at least one hierarchy template creation icon.

7. A graphical user interface for allowing a plant designer to create a hierarchy from a hierarchy template in a computer environment, the graphical user interface comprising:
a graphical template menu displaying at least one hierarchy template icon, each of the at least one hierarchy template icons having a template hierarchy comprising a plurality of plant-group-type icons at unique levels of subordination in a tree structure;
a plant-group-type menu displaying a plurality of distinct plant-group-type icons in a list structure, each of the plant-group-type icons configured for graphical selection by the plant designer;
a graphical editing interface configured to allow the plant designer to create a new hierarchy from a hierarchy template, by:
selecting from the graphical template menu a hierarchy template icon;
selecting from the list in the plant-group-type menu a first plant-group-type icon, and graphically placing the first plant-group-type icon into the tree structure of the template hierarchy;
selecting from the plant-group-type menu, a second plant-group-type icon, and graphically placing the second plant-group-type icon into the tree structure of the hierarchy template, subordinate to the first plant-group-type icon in the tree structure;
selecting from the plant-group-type menu a plurality of other plant-group-type icons, and graphically placing the plurality of plant-group-type icons into the hierarchy template, wherein any icon may have one or more of the other plant-group-type icons as an immediate subordinate.

8. The graphical user interface for allowing a plant designer to create a hierarchy from a hierarchy template of claim 7, wherein the graphical editing interface is further configured to automatically rearrange plant group type icons upon the addition, by the plant designer, of an additional plant group type icon into the hierarchy.

9. The graphical user interface for allowing a plant designer to create a hierarchy from a hierarchy template of claim 7, wherein the graphical editing interface is further configured to allow the plant designer to couple, to a plant group type icon within the hierarchy, a database.

10. The graphical user interface for allowing a plant designer to create a hierarchy from a hierarchy template of claim 7, wherein the graphical editing interface is further configured to allow the plant designer to graphically move a plant group type icon from one location within a hierarchy to another location within the hierarchy.

11. The graphical user interface for allowing a plant designer to create a hierarchy from a hierarchy template of claim 7, wherein the graphical editing interface is further configured to allow the plant designer to change the name of a plant group type icon, while the plant group type icon is within a hierarchy.

12. The graphical user interface for allowing a plant designer to create a hierarchy from a hierarchy template of claim 7, wherein the graphical editing interface further includes a site menu with a plurality of icons representing a corresponding plurality of sites.

13. A non-transient computer readable medium having computer-executable code thereon, the computer-executable code configured to display on a display device:
a graphical template menu displaying at least one hierarchy template icon, each of the at least one hierarchy template icons having a template hierarchy comprising a plurality of plant-group-type icons at unique levels of subordination in a tree structure;
a plant-group-type menu displaying a plurality of distinct plant-group-type icons, each of the plant-group-type icons configured for graphical selection by the plant designer;
a graphical editing interface configured to allow the plant designer to create a new hierarchy from a hierarchy template, by:
selecting from the graphical template menu a hierarchy template icon;
selecting from the plant-group-type menu a first plant-group-type icon, and graphically placing the first plant-group-type icon into the template hierarchy tree structure;
selecting from the plant-group-type menu, a second plant-group-type icon, and graphically placing the second plant-group-type icon into the hierarchy template tree structure, subordinate to the first plant-group-type icon;
selecting from the plant-group-type menu a plurality of other plant-group-type icons, and graphically placing the plurality of plant-group-type icons into the hierarchy template tree structure, wherein any icon may have one or more of the other plant-group-type icons as an immediate subordinate.

14. The non-transient computer readable medium of claim 13, wherein the graphical editing interface is further configured to allow the plant designer to couple, to a plant group type icon within the hierarchy, a database.

15. The non-transient computer readable medium of claim 13, wherein the graphical editing interface is further configured to allow the plant designer to graphically move a plant group type icon from one location within a hierarchy to another location within the hierarchy by dragging and dropping the plant group type icon.

16. The non-transient computer readable medium of claim 13, wherein the graphical editing interface further includes a site menu with a plurality of icons representing a corresponding plurality of sites, each site comprising a database of hierarchies.

17. The non-transient computer readable medium of claim 13, further comprising computer-executable code configured to display on the display device:
at least one hierarchy template creation icon configured to create, when activated by a template editor, an editable hierarchy tile;
a plant-group-type menu displaying a plurality of distinct plant-group-type icons, each of the plant-group-type icons representing a sub-area of a plant, the sub-area to be described by design files stored in a database, and configured for graphical selection by the template editor;
the graphical editing interface further configured to allow the template editor to edit an editable hierarchy tile to create a new hierarchy template, by:
selecting, from the plant-group-type menu, a first plant-group-type icon;
graphically placing the first plant-group-type icon into the editable hierarchy template;
selecting, from the plant-group-type menu, a second plant-group-type icon;
graphically placing the second plant-group-type icon into the editable hierarchy template, such that the second plant-group-type icon is graphically subordinate to the first plant-group-type icon, and
saving the new hierarchy template to a computer memory.

18. The graphical user interface of claim 17, where the graphical editing interface is further configured to allow the template editor to:
select, from the plant-group-type menu, a third plant-group-type icon;
graphically place the third plant-group-type icon into the editable hierarchy template, such that the third plant-group-type icon is graphically subordinate to the second plant-group-type icon, and such that none of the first plant-group-type icon, the second plant-group-type icon, and the third plant-group-type icon have more than one immediately subordinate icon.

19. The graphical user interface of claim 18, where the graphical editing interface is further configured to automatically rearrange the first plant-group-type icon and the second plant-group-type icon when the template editor drops the third plant-group-type icon into the template.

20. The graphical user interface of claim 17, where each of the plurality plant-group-type icons is an object including structural metadata describing data storage qualities of data that can be stored in a database associated with the plant-group-type icon.
